(19) United States
(12) Patent Application Publication
(10) Pub. No.: US 2026/0228848 A1
(43) Pub. Date: Aug. 6, 2026

(54) A METHOD OF PROVIDING SERVICES USING VEHICULAR TRANSPORT

(71) Applicant: GRID SMARTER CITIES LTD, Newcastle-upon-Tyne (GB)

(72) Inventor: Neil HERRON, Newcastle-upon-Tyne (GB)

(73) Assignee: GRID SMARTER CITIES LTD, Newcastle-upon-Tyne (GB)

(21) Appl. No.: 19/147,854

(22) PCT Filed: Jan. 23, 2024
(86) PCT No.: PCT/GB2024/050171

§ 371 Date: Jul. 14, 2025

(30) Foreign Application Priority Data
Jan. 24, 2023 (GB) 2301026.7

(51) Int. Cl. G06Q 50/40; G06Q 10/02

(52) U.S. Cl. CPC G06Q 50/40; G06Q 10/02; G06Q 2240/00

(57) ABSTRACT

A method of providing services, in particular care services for patients in their own homes, using vehicular transport is-disclosed provided. The first step is to allocate a job at a location, such as a patient's home, to a user, such as a carer, or to a vehicle used by that carer. On a device associated with the carer or the vehicle the position of the vehicle is updated to a central system. When a first trigger event, such as breaching a geofence, occurs within a boundary relative to the location, the central system triggers a temporary parking restriction exemption for the vehicle allowing the vehicle to park without incurring a fine and/or having to pay a parking charge. Once the service or care has been provided and a second trigger event occurs, ending the parking restriction.

The present invention relates to a method of providing services using vehicular transport and relates particularly, but not exclusively, to a method of optimising services provided by carers and utility workers when driving a vehicle to the location of the job. Other such services include NHS community Nurses and GPs, social care workers, telecom workers, domestic services and domestic maintenance services.

Jobs that require daily multiple trips to customer or patients' houses are common. One sector in particular that requires workers to travel to homes is the care sector. These jobs require a carer to visit patients at their homes of residence to offer support, treatments and welfare checks. Unfortunately, a common issue with travelling to a resident's home to provide care is the lack of parking available. Carers working in the Adult Social Care sector face a number of operational difficulties one of which is finding satisfactory, legal parking as close to the care recipient as possible to enable services to be delivered efficiently.

Many people live in built-up areas with no driveways and only on-street parking. To park in residential streets the vehicle usually requires a permit to be displayed. Other times there are no on-street parking spaces available and the only areas with space to park have double or single yellow lines. Not being able to park near a patient's home will either require the carer to walk further, wait for a space to become available or request a visitor parking permit, requiring the person to collect the permit, place it in their car and return the permit after the care has been provided. Both options however result in the carer being late for their patient and/or not being able to spend their full allotted time helping them. This can further result in reduced quality of care and carer stress due to workload and time pressures. Additionally, many care staff and companies providing care staff only get paid for the time care is provided and do not get paid for the time they spend travelling. It is also the case that in many places there is a lack of care staff available to meet the needs of adults in their community and these issues lead to problems with staff retention across the industry due to low level renumeration and occupational stresses and pressures. There is therefore a need to increase the efficiency of travel between locations to maximise the time the care staff can provide the care and support that is needed.

Preferred embodiments of the present invention seek to overcome or alleviate the above described disadvantages of the prior art.

According to an aspect of the present invention there is provided a method of providing services using vehicular transport comprising the steps:
allocating a job at a location to a user and/or a vehicle having a device associated therewith;
said device updating a position of said vehicle to a central system;
said central system triggering a temporary parking restriction exemption when a first trigger event occurs within a boundary relative to said location; parking said vehicle;
providing a service at said location; and
said central system ending said temporary parking restriction exemption when a second trigger event occurs.

Enabling a temporary parking restriction exemption (also known as a dispensation or waiver) allows visitors, such as care workers or service engineers to park near their required location and perform their service without the need for paying a parking fee at a parking meter, allows them to park in a residents only space or allows parking in locations where vehicles are normally prohibited from parking. Being able to park near their client reduces many time-consuming tasks. For example, it decreases the amount of time the career has to spend looking for a suitable parking space. If there are no suitable parking spaces, it reduces both the walking time to and from the location for which the service is to be provided.

Along with reducing wasted time it also reduces the worry and stress a visitor would experience when looking or thinking about a car parking space near their client. By reducing emotional stress levels, the visitor can perform their service much more effectively and without worry, thereby bring a more gratifying experience for the client.

Unlike a blue badge parking exemption, that allows (with exception, such as loading bays, areas where loading is prohibited at times indicated by single or double yellow kerb blips, bus stop clear ways or red routes) the user to park anywhere at any time, this process only allows a temporary parking exemption for a specific duration in a specified location. Furthermore, it allows a carer in a specific vehicle (and therefore, a specific vehicle registration number) to have multiple short term exemptions in predefined areas that are only relevant to the vehicles VRN and the specific jobs being undertaken, such as multiple care visits. This negates any chance that the exemption could be misused or mistreated. When the parking exemption is triggered by the user the exemption only applies to an area around or near the clients home or work location, for a specific vehicle and for a limited period of time. The user will know how long the exemption lasts and can either use the whole of the allocated time or it can be shortened if the second triggering mechanism is activated. As a result, it is almost impossible for the system to be abused to avoid paying parking charges at times other than when they are required for completing work. It is typically the case, in particular in the UK, that the same organisation that is responsible for, and therefore pays for, social care is also responsible for, and therefore collects, payments for parking as well as the issuing of penalty charge notices (parking fine). In the UK, these organisations are known as councils or local/unitary authorities. It is therefore currently the case that a carer, working for a care providing company, will go through the following process in relation to parking charges. Upon parking their vehicle, they will pay for the parking, at a meter, by buying a ticket or by using an app on a mobile device. They then undertake their care responsibilities and move onto another job. Periodically, they will claim back all of the parking charges they have received by providing evidence (in the form of receipts) of the expenses they have incurred. As part of the process of being paid for the care provided, the care company may apply to the council to reclaim the parking charges incurred. In the present invention all of those administrative processes are eliminated, and payments do not have to be passed between any people or organisations. The person providing the care does not have to wait to be reimbursed for parking charges they have incurred, nor will they face the threat of a penalty charge notice, appeals process or recovery action.

In a preferred embodiment the first trigger event comprises sending a trigger signal to said central system when said vehicle breaches said boundary.

In another preferred embodiment the first trigger event comprises causing said device to send a trigger signal to said central system when said device is within said boundary.

In a further preferred embodiment, the first trigger event comprises sending a trigger signal to said central system when ignition of said vehicle is turned off.

In an additional preferred embodiment, the second trigger event comprises sending a trigger signal to said central system when said vehicle breaches said boundary.

In a preferred embodiment the second trigger event comprises sending a trigger signal to said central system when said vehicle breaches said boundary.

In another preferred embodiment the second trigger event comprises leaving said location.

In a further preferred embodiment, the boundary is defined by a circle of a predetermined radius.

In an additional preferred embodiment, the boundary is defined by a travelling distance from the location.

In preferred embodiment said boundary is defined by a time required to travel from the location.

In another preferred embodiment the method further comprises the step of notifying a recipient when a first trigger event and/or second trigger event has occurred.

By including an event trigger notification to a recipient or third party member enables the recipient to know when the carer has arrived at the client's house and/or when they have left. If the recipient is the agency or workplace of the user it will give assurances to the agency/organisation that the correct visits have been undertaken within a certain time limit. If the recipient is a relative or friend, they will take comfort and assurance knowing that their relative/friend is currently being cared for. These notifications would also enable an automated archive of activity to be established.

Preferred embodiments of the present invention will now be described, by way of example only, and not in any limitative sense with reference to the accompanying drawings in which:

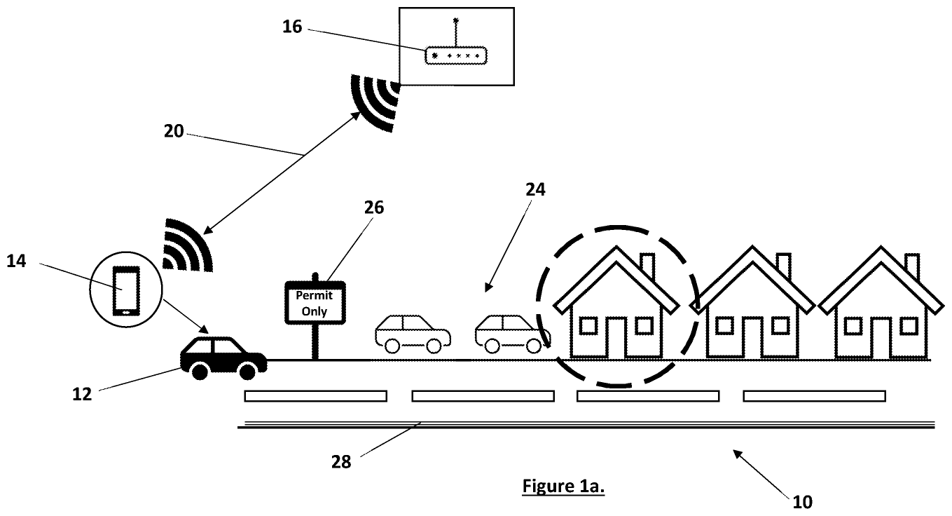

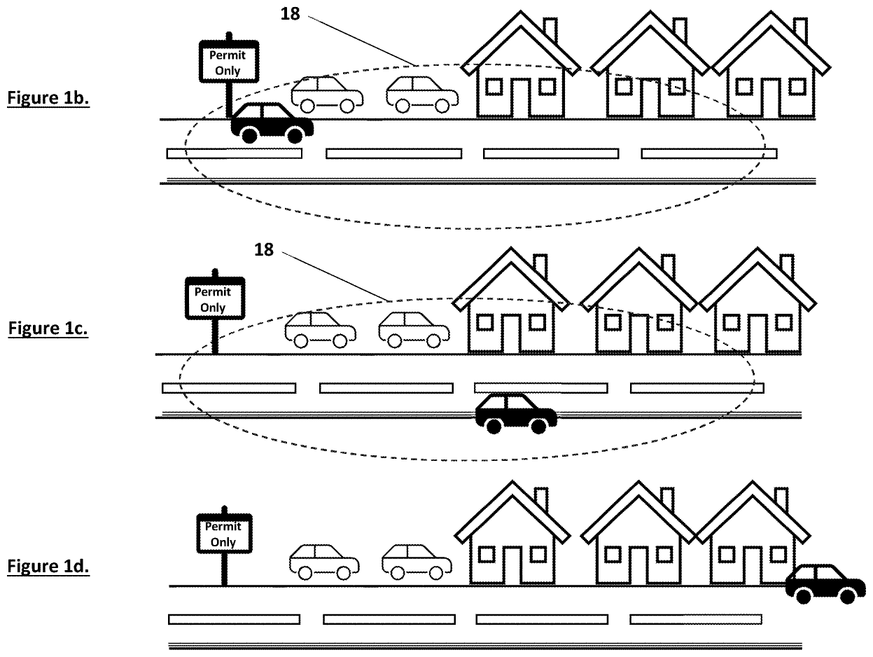

FIGS. 1a to 1d show an example journey of a vehicle providing a service using vehicular transport of the present invention; and

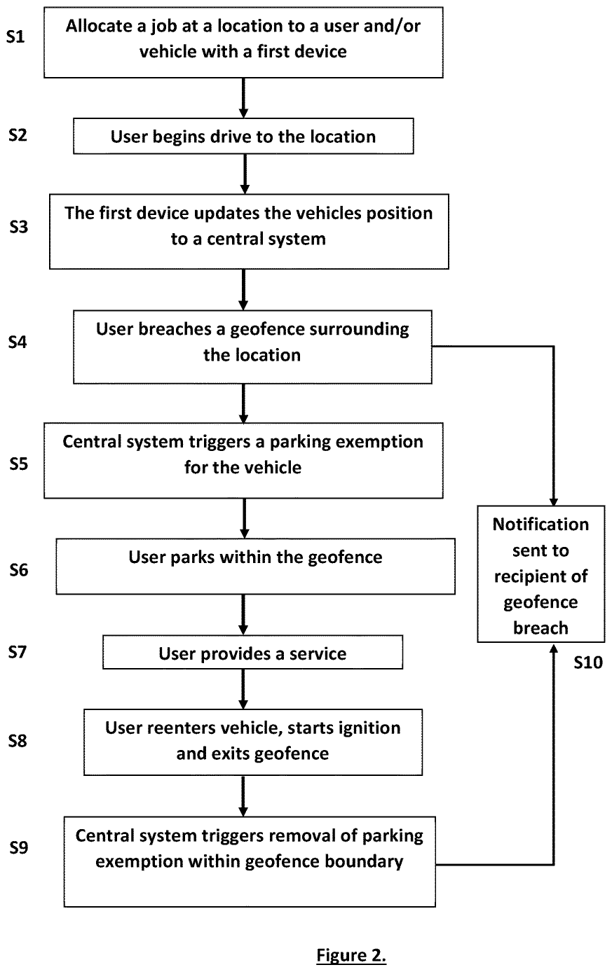

FIG. 2 is a flowchart chart of FIG. 1 of the present invention.

Referring initially to FIG. 1, a method of providing a service using vehicular transport enables a user (not shown), to work at a location 10, travel there in a vehicle 12 and utilises a device 14. The location 10, indicated by the dashed circular line is an area or a house in which a job or service is situated. The job is allocated to either the user or the vehicle 12. When the job is issued to the user, they can receive the job through an online system connected to a central server 16. When the vehicle has received the job, the location and time will be uploaded to the vehicle's internal computer for the user to access. The vehicle 12 is used by the user to travel to the location 10. Either the user has the device 14 on their person, such as a mobile phone and the like or the vehicle 12 has the device 14 installed in the vehicle's computer system. The device 14 will further include an app or inbuilt service that enables a communication link 20 to form between the device and the central server 16. Most typically, the communication link 20 will be a wireless mobile telephone network, although any other suitable communication method could be used. The central server 16 is a server based system that can send and receive information to the appropriate devices and services. In this case the central server 16 has the information associated with the agent or representative allocated to the job or service.

Once the central server 16 has the location (such as geocoordinates, a postcode or house address) of the service, a geofence 18 is established. The geofence 18 is an area surrounding the location 10 and has no visible markings. FIG. 1 shows the geofence 18 surrounding the client's home 10. FIGS. 1a to 1d shows surrounding a portion of a single road running adjacent the clients home 10. Further examples of other such geofence 18 boundaries could be an area including several roads extending from the clients' home or a residential car park attached to the home. FIG. 1a to 1d shows within the geofence boundary 18 that there are parking spaces near the house. However, each of the car parking spaces has been taken up by other vehicles 24. Furthermore, as an example of a typical residential area there is a sign 26 showing that only car permit owners are allowed to park along that designated section of road. Opposite the client's home 10 there is a space of road where no cars are parked however, the road is clearly marked with double yellow lines 26. These signs 24 and road markings would indicate that if the user where to park their vehicle in any of the above area's they could receive a parking fine if parked without a permit or along the stretch of road marked by double yellow lines.

The size of the geofence 18 is determined by a radius around the location 10, typically a radius of up to 100 m is generated around the client's address. This radius could also be controlled by a maximum distance that the user can walk from their vehicle to the location. That is, a maximum distance that could be conceivably covered on foot from the vehicle to the clients home without using up too much of the appointed time. When the geofence is determined by walking distance, it takes the shape of an irregular polygon.

Operation of the method of providing a service using vehicular transport will now be described. Referring now to FIGS. 1a to 1d and FIG. 2, the steps taken for a user to provide a service and receive a parking exemption (also known as a dispensation or waiver) are highlighted in FIG. 2, and FIGS. 1a to 1d show a visual representation of the geofence boundary 18 being created and the area for which it covers.

A job is allocated at a location 10 to a user or a vehicle 12 with a device 14. The device 14 could be located on the user as a mobile phone or located within the vehicles computer (S1). The user responds to the job and the location, with the central server 16 is updated with the details of the service provider. These details could include who is taking the job or the vehicle registration plate of the vehicle going to the location. It could also include a rough estimate of the time the user will arrive at the location.

In other such instances, a manifest of diary appointments and schedule times for each appointment will be predetermined. These times and appointments are uploaded to the central server 16 (ahead of time) along with expected locations and schedules.

The user enters their vehicle 12, either with device 14 on their person or the device already located in the vehicle, and begins to drive towards the location 10 (S2). During the journey the communication link 20 between the device 14 and the central server 16 is used to continually updated the server with the vehicle's location. Before the arrival of the user the geofence boundary 18 is established around the vicinity of the location 10 (S3).

As the vehicle 14 arrives nearer the location 10 the vehicle breaches the geofence boundary 18. Once this breach has been made (S4) an update is sent to the central server 16 via the communication link 20. If the agency or workplace of the user has requested an alert when the geofence boundary has been breached, a notification will be sent to the recipient (S10). This notification will tell the recipient that the user or carer has arrived at their destination and the time of arrival. This notification could also be sent to a third party member, such as a relative or friend of the person being cared for, telling the recipient that the care is about to be delivered and by whom. The notifications could be in the form of an SMS message, an update to the central server or automatic update using an IoT device such as a tablet or smartphone or smart wearable. The central server 16 allocates a parking exemption for the vehicle 12 within the geofence boundary 18 (S5).

The user is now allowed to park in areas that would have previously required a parking charge to be paid or could have resulted in a parking fine being issued. For example, the vehicle could be allowed to park in a space that would usually require a parking permit, as shown by a permit sign 26. Alternatively, or in addition, the vehicle 12 can be parked across a single or double yellow line 28 without receiving a parking fine. As a further alternative or addition, the vehicle 12 could be parked in a standard on or off-street local authority parking space which requires a ticket to be purchased and displayed in the vehicle or the ticket can be paid for using an app on a mobile device. In this instance the exemption makes it unnecessary to purchase the ticket. The exemption that is applied may vary depending upon the circumstances, such as location or time of day, and more than one of the examples of exemptions might be applicable.

Once the user has parked their vehicle in a now permitted parking location, they leave their vehicle 12 and walk to the client's home (S6). The user then provides their service to the client (S7).

Once the required service is completed the user walks back to their vehicle 12 and starts the ignition. As the user begins drives along the road away from the clients home the geofence 18 is breached for a second time (S8). This second breach triggers the central system 16 to remove the geofence boundary 18 surrounding the location 10 (S9) and the parking restriction exemption ends. A further notification can be sent informing the recipient (agency/workplace, central server or relative/friend) that the user has exited the geofence boundary (S10). There are alternative or additional ways in which the parking restriction exemption can be ended. These include, but are not limited to for example, the restarting of the vehicle or initial movement of the vehicle after parking is used as the trigger to end the parking restriction exemption. This could be accompanied by a confirmation on the device 14. Another alternative is that a time limit is placed on the parking restriction exemption or the restriction is ended manually using the device 14. A further alternative of triggering the end of an exemption is the user accepting their next job allocated by the central server or the agency.

Furthermore, combinations of these triggers can be used as a failsafe to ensure that parking restriction exemptions cannot be abused but also to ensure that an exemption is not accidentally ended when it is not intended.

It will be appreciated by persons skilled in the art that the above embodiments have been described by way of example only and not in any limitative sense, and that various alterations and modifications are possible without departure from the scope of the protection which is defined by the appended claims. For example, the job could also be received verbally or through a separate system to the central server, rather than through a device. If the job is allocated verbally the user could update the central server with the job allocation, user name, vehicle registration and the location of the job. Thereby, the central server would know when to activate the parking exemption for the correct location and service provider.

1. A method of providing services using vehicular transport comprising the steps:
allocating a job at a location to a user and/or a vehicle having a device;
said device updating a position of said vehicle to a central system;
said central system triggering a temporary parking restriction exemption when a first trigger event occurs within a boundary relative to said location;
parking said vehicle;
providing a service at said location; and
said central system ending said temporary parking restriction exemption when a second trigger event occurs.

2. A method according to claim 1 wherein said first trigger event comprises sending a trigger signal to said central system when said vehicle breaches said boundary.

3. A method according to claim 1 wherein said first trigger event comprises causing said device to send a trigger signal to said central system when said device is within said boundary.

4. A method according to claim 1 wherein said first trigger event comprises sending a trigger signal to said central system when ignition of said vehicle is turned off.

5. A method according to claim 1 wherein said second trigger event comprises sending a trigger signal to said central system when said vehicle breaches said boundary.

6. A method according to claim 1 wherein said second trigger event comprises sending a trigger signal to said central system when said vehicle breaches said boundary.

7. A method according to claim 1 wherein said second trigger event comprises leaving said location.

8. A method according to claim 1 wherein said boundary is defined by a circle of a predetermined radius.

9. A method according claim 1 wherein said boundary is defined by a travelling distance from the location.

10. A method according to claim 1 wherein said boundary is defined by a time required to travel from the location.

11. A method according to claim 1 further comprising the step of notifying a recipient when a first trigger event and/or second trigger event has occurred.
